(19) United States
(12) Patent Application Publication
(10) Pub. No.: US 2013/0047001 A1
(43) Pub. Date: Feb. 21, 2013

(54) LOAD CARD FOR TESTING SLOT CONNECTORS OF MOTHERBOARD

(71) Applicants: YING-BIN FU, Shenzhen City (CN); ZE-YUN WU, Shenzhen City (CN)

(72) Inventors: YING-BIN FU, Shenzhen City (CN); ZE-YUN WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/447,289

(22) Filed: Apr. 16, 2012

(30) Foreign Application Priority Data
Aug. 18, 2011 (CN) 201110237515.X

(51) Int. Cl. G06F 1/26; G06F 13/14

(52) U.S. Cl. 713/300

(57) ABSTRACT

An exemplary load card includes an input unit, a processing unit, and a load unit. When inputting a predetermined voltage and a predetermined load power via the input unit, the processing unit receives and processes the predetermined voltage and the load power, and generates and outputs a corresponding binary control voltage. The load unit receives and converts the binary control voltage into an analog control voltage. Under the control of the analog control voltage, the load unit receives the predetermined voltage from a motherboard, and outputs the predetermined power to the motherboard.

### BACKGROUND

1. Technical Field

The disclosure generally relates to load cards, such as a load card for testing peripheral component interconnect (PCI) slots of a motherboard.

2. Description of Related Art

A motherboard usually has different types of peripheral component interconnect (PCI) slots, such as, a standard PCI slot, a PCI-Express (PCI-E) slot, and a PCI-extended (PCI-X) slot, for adapting different types of PCI devices. To ensure all of the PCI slots work normally, the performance of each of the PCI slots should be tested. In testing, each of the PCI slots needs a corresponding load card. Therefore, different load cards to test the PCI slots of the motherboard are needed, which is inconvenient for the tester.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments.

FIG. 1 is a block diagram of a load card, according to an exemplary embodiment, and showing the load card connected to a motherboard.

FIG. 2 is a circuit diagram of part of the load card of FIG. 1, showing one embodiment of a load unit of the load card.

### DETAILED DESCRIPTION

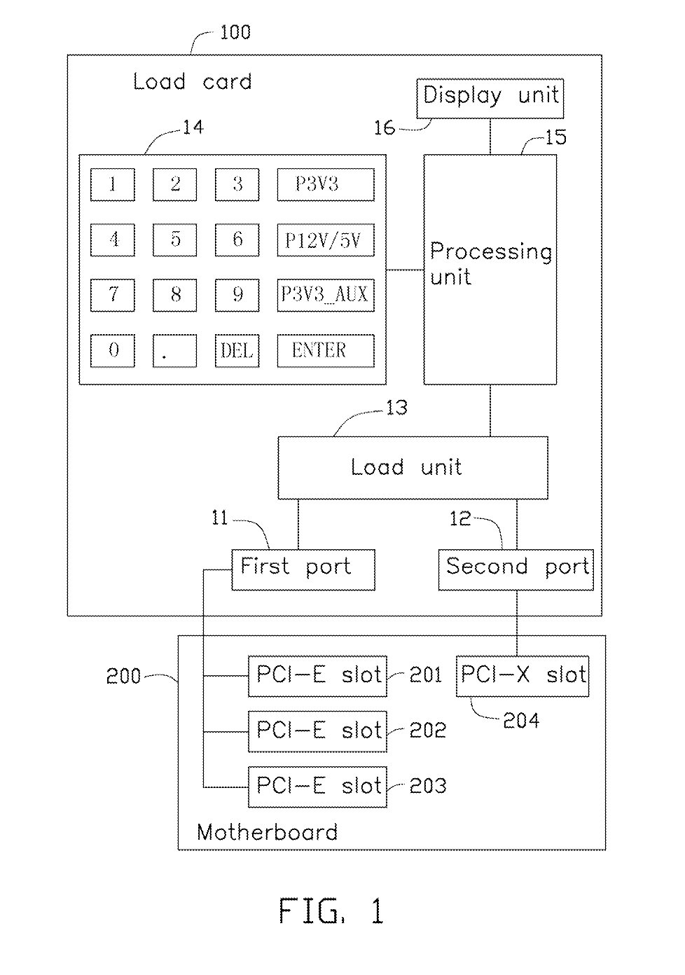

FIG. 1 is a block diagram of a load card, according to an exemplary embodiment. The load card 100 is used for testing a motherboard 200. The motherboard 200 includes at least one PCI slot arranged thereon. Each of the at least one PCI slot is one of a PCI-E slot and a PCI-X slot. The PCI-E slot can be a PCI-E x4 slot, a PCI-E x8 slot, or a PCI-E x16 slot. In the present embodiment, there are three PCI-E slots 201, 202, 203, and one PCI-X slot 204. When the motherboard 200 is set at a working mode, each of the PCI slots has two different working voltages. In detail, the PCI-E slots 201, 202, 203 each have two working voltages (hereinafter, “the first two working voltages”) of 12 volts and 3.3 volts; and the PCI-X slot 204 has two working voltages (hereinafter, “the second two working voltages”) of 5 volts and 3.3 volts. Alternatively, when the motherboard 200 is set at a sleep mode, each of the PCI slots of both the PCI-E type and the PCI-X type has a sleep voltage of 3.3 volts.

The load card 100 includes a first port 11, a second port 12, a load unit 13, an input unit 14, a processing unit 15, and optionally a display unit 16. The first port 11, the second port 12, the load unit 13, the input unit 14, the processing unit 15, and the display unit 16 are all integrated on a circuit board (not labeled).

The first port 11 is a PCI-E x4 gold finger connector that can fit into the PCI slot of the PCI-E type, e.g. the PCI-E slots 201-203 of the motherboard 200. When the first port 11 is connected to the motherboard 200, the first port 11 receives the first two working voltages (i.e., the 12 volts voltage, and the 3.3 volts voltage), or the sleep voltage (i.e., the 3.3 volts voltage), from the motherboard 200. The second port 12 is a PCI-X gold finger connector that can fit into the PCI slot of the PCI-X type, e.g. the PCI-X slot 204 of the motherboard 200. When the second port 12 is connected to the motherboard 200, the second port 12 receives the second two working voltages (i.e., the 5 volts voltage, and the 3.3 volts voltage), or the sleep voltage (i.e., the 3.3 volts voltage), from the motherboard 200. When the PCI slots of the motherboard 200 need to be tested, the load card 100 is connected to one of the PCI slots via the first port 11 or the second port 12, according to the type of the PCI slot. In the present embodiment, the load card 100 is connected to the motherboard 200 respectively via the connection between the first port 11 and the three PCI-E slots 201, 202, 203, and the connection between the second port 12 and the PCI-X slot 204, one-by-one in succession as each PCI slot is tested.

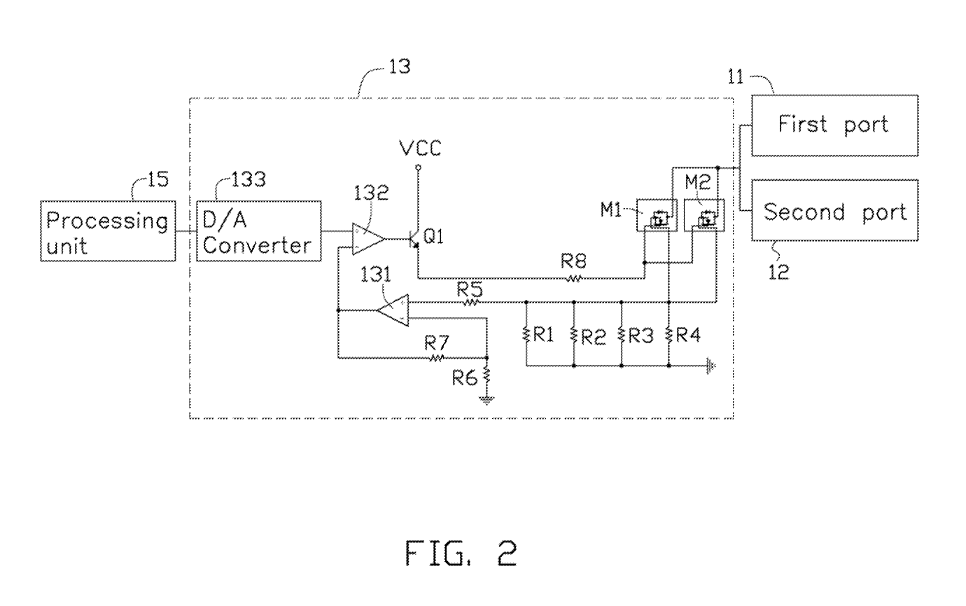

Referring to FIG. 2, the load unit 13 includes a group of loads, a group of resistors R1-R4 which are electronically connected in parallel, an amplifier 131, a comparator 132, a digital/analog (D/A) converter 133, and a bipolar junction transistor (BJT) Q1. In the present embodiment, the group of loads includes two metal-oxide-semiconductor field-effect-transistors (MOSFETs) M1, M2. Drains of the MOSFETs M1, M2 are electronically connected to both the first port 11 and the second port 12. Sources of the MOSFETs M1, M2 are electronically connected to one end of each resistor R1-R4. The other ends of all the resistors R1-R4 are electronically connected to ground. In the present embodiment, the amplifier 131 can be an LM324 amplifier. The amplifier 131 is electronically connected between the resistors R1-R4 and the comparator 132. The amplifier 131 amplifies a voltage across the resistors R1-R4, and outputs an amplified voltage to the comparator 132.

A positive input of the amplifier 131 is connected to the drains of the MOSFETs M1, M2 via a resistor R5. A negative input of the amplifier 131 is connected to ground through a resistor R6. An output of the amplifier 131 is connected to ground through a resistor R7 and the resistor R6. A negative input of the comparator 132 is connected to the output of the amplifier 131. A positive input of the comparator 132 is connected to the processing unit 15 via the D/A converter 133. An output of the comparator 132 is connected to a base of the BJT Q1. A collector of the BJT Q1 is connected to a power supply VCC. An emitter of the BJT Q1 is connected to the gates of the MOSFETs M1, M2 through a resistor R8.

The input unit 14 is electronically connected to the processing unit 15, and can be a keyboard or a touch panel. In the exemplary embodiment, the input unit 14 is a keyboard. The input unit 14 includes a group of numeric keys, and a group of function keys.

The group of numeric keys includes ten numeric keys “0”-“9” and a decimal key “.”, and is capable of setting and supplying a predetermined power to the motherboard 200. The group of function keys includes a P3V3 key, a P12V/5V key, a P3V3_AUX key, an enter key ENTER, and a delete key DEL. The P3V3 key is operated by a tester to activate the load card 100 to receive one of the first two working voltages (e.g., the 3.3 volts voltage) from one of the tested PCI-E slots 201-203, or one of the second two working voltages (e.g., the 3.3 volts voltage) from the tested PCI-X slot 204. The P12V/5V key is operated by the tester to activate the load card 100 to receive the other of the first two working voltages (e.g., the 12 volts voltage) from one of the tested PCI-E slots 201-203, or the other of the second two working voltages (e.g., the 5 volts voltage) from the tested PCI-X slot 204. The P3V3_AUX key is operated by the tester to activate the load card 100 to receive the sleep voltage (i.e., the 3.3 volts voltage) from one of the tested PCI-E slots 201-203, or from the tested PCI-X slot 204, when the motherboard 200 is at the sleep mode.

For example, if the motherboard 200 is connected to the load card 100 by the connection between the first port 11 and one of the tested PCI-E slots 201-203, a number (e.g. 24) is input by a tester to the input unit 14, and the P3V3 key is operated by the tester, whereupon the load card 100 receives one of the first two working voltages (e.g., the 3.3 volts voltage) from the one of the tested PCI-E slots 201-203, and provides a load power of about 24 watts to the motherboard 200. Alternatively, if the motherboard 200 is connected to the load card 100 by the connection between the second port 12 and the PCI-X slot 204, a number (e.g. 24) is input by the tester to the input unit 14, and the P3V3 key is operated by the tester, whereupon the load card 100 receives one of the second two working voltages (e.g., the 3.3 volts voltage) from the tested PCI-X slot 204, and provides a load power of about 24 watts to the motherboard 200. The delete key DEL is used to delete the input numbers.

The processing unit 15 can be a single chip microcomputer (SCM) or a micro control unit (MCU), and is connected to the D/A converter 133. In this embodiment, the processing unit 15 is an AT89s51 MCU. When the numeric keys and the functional keys are operated by a tester, a predetermined voltage and a load power are input to the processing unit 15 from the input unit 14. The processing unit 15 receives and processes the predetermined voltage and the load power, thereby generating and outputting a corresponding binary control voltage in the range of 00000001-11111111 according to the predetermined voltage and the load power. Then the D/A converter 133 receives and converts the binary control voltage into an analog control voltage, and transmits the analog control voltage to the comparator 132. In addition, if the binary control voltage exceeds a predetermined range of voltages, the processing unit 15 determines that the binary control voltage is invalid data, and stops transmission of the binary control voltage to the D/A converter 133.

In detail, according to a performance of the amplifier 131, a voltage U₁ of the positive input of the amplifier 131 can be calculated according to the following formula (1):

U₁=I×R (1)

wherein the parameters R and I can be respectively calculated according to the following formula (2) and formula (3):

$$\begin{matrix}R = \frac{R 1 R 2 R 3 R 4}{R 2 R 3 R 4 + R 1 R 3 R 4 + R 1 R 2 R 4 + R 1 R 2 R 3} & ( 2 ) \\ I = \frac{P}{{U}_{O}} & ( 3 )\end{matrix}$$

In formula (3), the parameter P is a power of the MOSFETs M1, M2, which is defined to be equal to the predetermined load power; and the parameter U₀ is a voltage input to the MOSFETs M1, M2, which is defined to be equal to the predetermined voltage, e.g., the first or second two working voltages, or the sleep voltage.

According to above formulas (1), (2), and (3), the parameter U₁ can be calculated according to the following formula (4):

$${U}_{1} = \frac{P}{{U}_{O}} \times \frac{R 1 R 2 R 3 R 4}{R 2 R 3 R 4 + R 1 R 3 R 4 + R 1 R 2 R 4 + R 1 R 2 R 3} \qquad ( 4 )$$

In addition, an output voltage U₂ of the amplifier 131 can be calculated according to the following formula (5):

U₂=β×U₁ (5)

wherein the parameter β is a common emitter current gain of the amplifier 131, and can be calculated according to the following formula (6):

$$β = \frac{R 7}{R 6} \qquad ( 6 )$$

Thus, the parameter U₂ can be calculated according to the following formula (7), based on above formulas (4), (5), and (6).

$${U}_{2} = \frac{R 7}{R 6} \times \frac{P}{{U}_{O}} \times \frac{R 1 R 2 R 3 R 4}{R 2 R 3 R 4 + R 1 R 3 R 4 + R 1 R 2 R 4 + R 1 R 2 R 3} \qquad ( 7 )$$

Due to the output of the amplifier 131 being connected to the negative input of the comparator 132, a voltage U₃ of the negative input of the comparator 132 is obtained according to the following formula (8):

$${U}_{3} = \frac{R 7}{R 6} \times \frac{P}{{U}_{O}} \times \frac{R 1 R 2 R 3 R 4}{R 2 R 3 R 4 + R 1 R 3 R 4 + R 1 R 2 R 4 + R 1 R 2 R 3} \qquad ( 8 )$$

Furthermore, according to a performance of the comparator 132, when the voltage of the negative input of the comparator 132 equals the voltage of the positive input of the comparator 132 (i.e., the analog control voltage), the output of the comparator 132 outputs a high level voltage (e.g., logic 1), and the BJT Q1 is turned on. Then, the motherboard 200 supplies the predetermined voltage to the load card 100 via the connection between the first or second port 11 or 12 and the PCI slot being tested, and obtains the predetermined load power from the load card 100. Thus, the processing unit 15 obtains the analog control voltage according to the above-described formula (8).

For example, when one of the PCI-E slots 201-203 needs to be tested, and the P12V/5V key is pressed and a number “24” is input, the processing unit 15 obtains a binary number corresponding to an analog control voltage of about 1 volt obtained by the formula (8), and then the D/A converter 133 transforms the binary number to an analog control voltage (or signal), and outputs the analog control voltage to the comparator 132. The comparator 132 receives the analog control voltage, and outputs a high level voltage (e.g., logic 1), thereby causing the BJT Q1 to be turned on. Thus, the load unit 13 receives a 12 volts voltage from the motherboard 200, and outputs the predetermined power of about 24 watts to the motherboard 200.

In use of the load card 100, when one of the PCI slots of the motherboard 200 needs to be tested, the load card 100 is connected to the motherboard 200 through the first port 11 or the second port 12 according to the type of the tested PCI slot. A predetermined voltage is selected via the P3V3 key, the P12V/5V key, or the P3V3_AUX key, and a predetermined load power is input via the numeric keys. The processing unit 15 receives and processes the predetermined voltage value and the load power value after the enter key ENTER is pressed, thereby generating and outputting a corresponding binary control voltage according the formula (8). The D/A converter 133 receives and converts the binary control voltage into an analog control voltage, and transmits the analog control voltage to the comparator 132. The comparator 132 receives the analog control voltage, and outputs a high level voltage (e.g., logic 1), thereby causing the BJT Q1 to be turned on. Thus, the load unit 13 receives the predetermined voltage from the motherboard 200, and outputs the predetermined load power to the motherboard 200.

When the load card 100 includes the display unit 16, the display unit 16 can be a digital display, and is connected to the processing unit 15. The display unit 16 is capable of displaying the predetermined voltage and the load power of the input unit 11.

The load card 100 can be adapted to apply to multiple kinds of PCI slots, such as a PCI-E x4 slot, a PCI-E x8 slot, a PCI-E x16 slot, and the PCI-X slot 204 described above. When any one of the different kinds of PCI slots needs to be tested, the load card 100 can supply different load powers to the corresponding PCI slot, as desired. Thereby, testing of the performance of the PCI slot is convenient, and different test demands for testing different kinds of PCI slots are satisfied.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A load card, comprising:
an input unit for inputting a predetermined voltage and a predetermined load power;
a processing unit connected to the input unit, wherein the processing unit receives and processes the predetermined voltage and the predetermined load power, and generates and outputs a corresponding binary control voltage; and
a load unit connected to the processing unit, wherein the load unit receives the binary control voltage and converts the binary control voltage into an analog control voltage, and under the control of the analog control voltage, the load unit receives the predetermined voltage from a motherboard connected to the load card, and outputs the predetermined power to the motherboard.

2. The load card according to claim 1, wherein the input unit is one of a keyboard and a touch panel.

3. The load card according to claim 1, wherein the load unit includes a group of loads, a group of resistors electronically connected in parallel, a comparator, a digital/analog (D/A) converter, and a bipolar junction transistor (BJT), the group of loads includes two metal-oxide-semiconductor field-effect-transistors (MOSFETs), drains of the MOSFETs are connected to the motherboard, sources of the MOSFETs are connected to ends of the resistors electronically connected in parallel, the other ends of the resistors are electronically connected in parallel and are all connected to ground, a negative input of the comparator is connected to sources of the MOSFETs, a positive input of the comparator is connected to the processing unit via the D/A converter, an output of the comparator is connected to a base of the BJT, a collector of the BJT is connected to a power supply, and an emitter of the BJT is connected to gates of the MOSFETs.

4. The load card according to claim 3, wherein the load unit further includes an amplifier, the amplifier is connected between the resistors electronically connected in parallel and the comparator, and the amplifier is capable of amplifying a voltage of the resistors electronically connected in parallel and outputting the amplified voltage to the comparator.

5. The load card according to claim 4, wherein a positive input of the amplifier is connected to the drains of the MOSFETs via a resistor, a negative input of the amplifier is connected to ground through another resistor, and an output of the amplifier is connected to the negative input of the amplifier.

6. The load card according to claim 1, further comprising a display unit connected to the processing unit, and capable of displaying the predetermined voltage and load power of the input unit.

7. The load card according to claim 6, wherein the display unit is a digital display.

8. The load card according to claim 4, wherein the processing unit obtains the binary control voltage according to the formula
$$β \times ( \frac{P}{{U}_{O}} ) \times R ,$$
wherein the parameter β is a common emitter current gain of the amplifier, the parameter P is a power of the MOSFETs which is defined to be equal to the predetermined load power, the parameter U₀ is a voltage of the MOSFETs which is defined to be equal to the predetermined voltage, and the parameter R is a resistance of the resistors electronically connected in parallel.

9. A load card for connecting to a motherboard, the motherboard including a first type of peripheral component interconnect (PCI) slot, and a second type of PCI slot, the load card comprising:
a first port matching the first type of PCI slot;
a second port matching the second type of PCI slot;
an input unit for inputting a predetermined voltage and a predetermined load power;
a processing unit connected to the input unit, wherein the processing unit receives and processes the predetermined voltage and the predetermined load power, and generates and outputs a corresponding binary control voltage; and
a load unit connected to the processing unit, wherein the load unit receives the binary control voltage and converts the binary control voltage into an analog control voltage, and under the control of the analog control voltage, the load unit receives the predetermined voltage from the motherboard via the first port or the second port, and outputs the predetermined power to the motherboard.

10. The load card according to claim 9, wherein the first type of the PCI slot includes a PCI-E x4 slot, a PCI-E x8 slot, and a PCI-E x16 slot, the second type of the PCI slot includes a PCI-X slot.

11. The load card according to claim 9, wherein the first type of PCI slot has first two working voltages when the motherboard being a working mode, and a sleep voltage when the motherboard being a sleep mode.

12. The load card according to claim 11, wherein the first two working voltages are 12 volts and 3.3 volts, and the sleep voltage is 3.3 volts.

13. The load card according to claim 12, wherein the second type of PCI slot has second two working voltages when the motherboard being a working mode, and a sleep voltage when the motherboard being a sleep mode.

14. The load card according to claim 13, wherein the second two working voltages are 5 volts and 3.3 volts, and the sleep voltage is 3.3 volts.

15. The load card according to claim 9, wherein the input unit includes a group of numeric key and a decimal key, and is capable of inputting the predetermined load power to the processing unit.

16. The load card according to claim 14, wherein the input unit includes a group of function keys, and is used to input the predetermined voltage to the processing unit.

17. A load card for connecting to a motherboard, comprising:
an input unit for inputting a predetermined voltage and a predetermined load power;
a processing unit connected to the input unit, wherein the processing unit receives and processes the predetermined voltage and the predetermined load power, and generates and outputs a corresponding binary control voltage;
a load unit connected to the processing unit, wherein the load unit receives the binary control voltage and converts the binary control voltage into an analog control voltage, and under the control of the analog control voltage, the load unit receives the predetermined voltage from the motherboard, and outputs the predetermined power to the motherboard; and
a display unit connected to the processing unit, and capable of displaying the predetermined voltage and load power of the input unit.

18. The load card according to claim 17, further comprising a first port matching a first type of PCI slot of the motherboard.

19. The load card according to claim 17, further comprising a second port matching a second type of PCI slot of the motherboard.
